(19) United States
(12) Patent Application Publication
(10) Pub. No.: US 2012/0035307 A1
(43) Pub. Date: Feb. 9, 2012

(54) PROCESS FOR MAKING STABLIZED POLYMERIC SYSTEMS WITH NANOSTRUCTURES

(76) Inventor: Chengqian Song, Green Brook, NJ (US)

(21) Appl. No.: 12/851,553

(22) Filed: Aug. 6, 2010

(51) Int. Cl. C08K 3/32; C08K 5/54; C08G 73/02; C08G 63/91; C08G 69/48; C08G 18/83; C08F 120/18; C08F 10/00

(52) U.S. Cl. 524/262; 524/416; 525/330.3; 525/330.5; 525/333.7; 525/333.8; 525/418; 525/420; 525/453; 525/540

(57) ABSTRACT

The present invention generally relates to a process for preparing stabilized polymeric systems with excellent light, thermal and oxidation stability using a redox formulation containing an oxidizing agent, a reducing agent, and/or nano-additives, and the polymer articles made therefrom.

### TECHNICAL FIELD

The present invention relates to a process for making stabilized polymeric systems with excellent light, thermal and oxidation stability using a redox formulation containing oxidizing agents, reducing agents, and/or nano-additives, and the polymer articles made therefrom.

### BACKGROUND

Most polymer materials need to have a stabilization package in order to achieve satisfactory performance in their thermal, light, and oxidation stability. The additives are normally added to the polymer materials during melt processing, such as screw extrusion, injection molding, casting, blow molding, etc. The efficiency of these additives is not only a function of the additives themselves but also a function of the distribution of such additives in the polymer matrix. For example, U.S. Pat. No. 6,677,395 disclosed a method to disperse the additives in a polymer composition in order to achieve better mechanical properties together with thermal stability. The better dispersion was achieved by the formation of compatibilizers in situ by promoting additives reacting with or grafting onto the polymeric material matrix.

When the additives are chemically bound to the polymeric materials, the distribution of such additives in the polymeric matrix tends to be more uniform. One of the methods to bind the additives to the polymer backbone is via grafting of functional additives by various methods known in the state of the art, such as by grafting reaction which may be conducted in polymer solutions, in the presence of solid polymer or with a polymer in molten state. The active sites on the polyolefin can be formed either in the presence of grafting additives, or contacted with the functional additives at a later stage. The grafting sites can be produced by treatment with a peroxide or any other chemical compound which is a free radical polymerization initiator capable of extracting a hydrogen free radical from the polymer backbone, or by irradiation with high energy ionizing radiation.

The free radicals produced in the reaction as a result of the degradation of peroxides or by irradiation treatment act as initiators for polymerization of the monomers, as well as active sites for grafting when the free radicals are formed on the olefin polymers. For example, U.S. Pat. No. 5,411,994 discloses a method for making polyolefin graft copolymers by irradiating olefin polymer particles and then treating with a vinyl monomer in liquid form under a non-oxidizing environment which is maintained throughout the process. U.S. Pat. No. 5,817,707 discloses a process for making a graft copolymer by irradiating a porous propylene polymer material in the absence of oxygen, adding a controlled amount of oxygen to produce an oxidized propylene polymer material and then heating, dispersing the oxidized polymer in water in the presence of a surfactant to react with a vinyl monomer by a redox initiator system.

The grafting reaction can be carried out on the polymer in solid state, at a temperature lower than the softening point of the polymer itself or in melt state, at a temperature above the melting point of the polymer. One example is that the graft copolymers are made in an extruder as disclosed in U.S. Pat. No. 3,862,265 in which an organic peroxide initiator was injected into the extruder to initiate the grafting reaction of polyolefins in molten state with vinyl monomers. The reactive extrusion, carried out on the polymer in molten state, offers many advantages such as a fast reaction rate and a simple reaction system. Since peroxides are unstable and explosive chemicals, they require special safe handling procedures to minimize the risk. Moreover, when a longer residence time is needed, a special loop around extruder or a batch reactor is preferred. In addition, since the free radical initiator used in such a process does not only initiate the graft copolymerization but also homopolymerization of the vinyl monomers, relatively low grafting efficiency often occurs and results in low degree of graft monomer content, thus reducing the value of the final products.

There is a need, therefore, for a process for making a stabilized, grafted polymeric system without homopolymerization. Accordingly, it is an object of this invention to produce a stabilized polymeric system using a redox system containing oxidizing agents and reducing agents.

### SUMMARY OF THE INVENTION

In accordance with the present invention, a stabilized polymeric material is made by using a redox system containing oxidizing agents and reducing agents.

In one embodiment, the present invention relates to a process making stabilized polymer concentrates comprising:

a) preparing a polymer mixture comprising:

I. about 10.0 to about 99.0 wt % of a polymer material (B);

II. about 0.5 to about 50.0 wt % of at least one reducing agent capable of being reacted with or grafted onto the polymer material (B) in the presence of free radicals;

III. about 0.5 wt % to about 50.0 wt % of an oxidizing agent capable of producing free radicals; and

IV. about 0 to about 5.0 wt % of a grafting catalyst;

b) extruding or reacting the polymer mixture at an elevated temperature, thereby producing a stabilized polymer concentrate; and optionally

c) pelletizing the stabilized polymer concentrate, thereby producing a pelletized polymer concentrate.

Preferably, the polymer mixture comprises about 0.01 to about 5.0 wt % of a grafting catalyst and the elevated temperature is about 80 deg C. to about 200 deg C. Most preferably, the polymer mixture comprises about 0.05 to about 2.0 wt % of a grafting catalyst and the elevated temperature is from about 110 deg C. to about 180 deg C.

In another embodiment, the present invention relates to a process for making a stabilized polymer blend comprising:

a) preparing a polymer mixture comprising:

I. about 50.0 to about 98.0 wt % of a polymer material (B);

II. about 0.1 to about 10.0 wt % of an oxidizing agent capable of producing free radicals;

III. about 0.1 to about 10.0 wt % of at least one reducing agent capable of being reacted with or grafted onto the polymer material (B) in the presence of free radicals; and

IV. about 0 to about 5.0 wt % of a grafting catalyst; and

b) extruding or reacting the polymer mixture at an elevated temperature, thereby producing a stabilized polymer blend; and optionally

c) pelletizing the stabilized polymer blend, thereby producing a pelletized polymer blend.

Preferably, the polymer mixture comprises about 0.01 to about 5.0 wt % of a grafting catalyst and the elevated temperature is about 80 deg C. to about 200 deg C. Most preferably, the polymer mixture comprises about 0.05 to about 2.0 wt % of a grafting catalyst and the elevated temperature is from about 110 deg C. to about 180 deg C.

### DETAILED DESCRIPTION OF THE INVENTION

The present invention relates to a process making stabilized polymeric concentrates and polymeric materials. Polymer material (B) suitable for this invention can be selected from olefin polymers or any type of polymer material that is suitable for melt processing at the extruder temperature, preferably at processing temperatures below 300.degree C., such as, vinyl polymers, polyethers, polyamide, polysolfones, polyureas, and polyurethanes, etc. The olefin polymer used in the present invention can be selected from:

(a) a crystalline homopolymer of propylene having an isotactic index greater than about 80%, preferably about 90% to about 99.5%;

(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;

(c) a crystalline, random terpolymer of propylene and two olefins selected from ethylene and C₄-C₈ α-olefins wherein the polymerized olefin content is about 1% to about 5% by weight, preferably about 1% to about 4%, when ethylene is used, and about 1% to about 20% by weight, preferably about 1% to about 16%, when the C₄-C₁₀ α-olefins are used, the terpolymer having an isotactic index greater than about 85%; and

(d) an olefin polymer composition comprising:

(i) about 10% to about 60% by weight, preferably about 15% to about 55%, of a crystalline propylene homopolymer having an isotactic index at least about 80%, preferably about 90 to about 99.5%, or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, preferably about 90% to about 99%, and an isotactic index greater than about 60%;

(ii) about 3% to about 25% by weight, preferably about 5% to about 20%, of a copolymer of ethylene and propylene or a C₄-C₈ α-olefin that is insoluble in xylene at ambient temperature; and

(iii) about 10% to about 80% by weight, preferably about 15% to about 65%, of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight, preferably about 10% to about 60%, most preferably about 12% to about 55%, of polymerized ethylene, and being soluble in xylene at ambient temperature and having an intrinsic viscosity of about 1.5 to about 6.0 dl/g;

wherein the total of (ii) and (iii), based on the total olefin polymer composition is about 50% to about 90% by weight, and the weight ratio of (ii)/(iii) is less than about 0.4, preferably 0.1 to 0.3, and the composition is prepared by polymerization in at least two stages;

(e) homopolymers of ethylene;

(f) random copolymers of ethylene and an α-olefin selected from C₃-C₁₀ α-olefins having a polymerized α-olefin content of about 1 to about 20% by weight, preferably about 2% to about 16%;

(g) random terpolymers of ethylene and two C₃-C₁₀ α-olefins having a polymerized α-olefin content of about 1% to about 20% by weight, preferably about 2% to about 16%;

(h) homopolymers of butene-1;

(i) paraffin wax;

(j) copolymers or terpolymers of butene-1 with ethylene, propylene or C₅-C₁₀ α-olefin, the comonomer content ranging from about 1 mole % to about 15 mole %; and

(k) mixtures thereof.

Preferably, the olefin polymer is selected from:

(a) a crystalline homopolymer of propylene having an isotactic index greater than about 80%, preferably about 90% to about 99.5%; and

(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;

Most preferably, the olefin polymer is a propylene homopolymer having an isotactic index greater than about 90%.

The useful polybutene-1 homo or copolymers can be isotactic or syndiotactic and have a melt flow rate (MFR) from about 0.1 to 150 dg/min, preferably from about 0.3 to 100, and most preferably from about 0.5 to 75.

These butene-1 polymer materials, their methods of preparation and their properties are known in the art. Suitable polybutene-1 polymers can be obtained, for example, by using Ziegler-Natta catalysts with butene-1, as described in WO 99/45043, or by metallocene polymerization of butene-1 as described in WO 02/102811, the disclosures of which are incorporated herein by reference.

Preferably, the butene-1 polymer materials contain up to about 15 mole % of copolymerized ethylene or propylene. More preferably, the butene-1 polymer material is a homopolymer having a crystallinity of at least about 30% by weight measured with wide-angle X-ray diffraction after 7 days, more preferably about 45% to about 70%, most preferably about 55% to about 60%.

In general the polymer material (B) is chosen according to the polymer matrix material that needs stabilization.

Besides the olefin polymer, a suitable polymer material (B) can be selected from copolymers of mono- and di-olefins with other vinyl monomers, for example, ethylene/alkyl acrylate copolymers, ethylene/alkyl methacrylate copolymers, ethylene/vinyl acetate copolymers, ethylene/acrylic acid copolymers and salts thereof (ionomers), and also mixtures thereof. It can also be selected from various polymers, for example polyamides. polystyrene, poly(p-methylstyrene), poly(α-methylstyrene), and other aromatic homopolymers and copolymers derived from vinyl-aromatic monomers, for example styrene, .alpha.-methylstyrene, all isomers of vinyltoluene, all isomers of ethylstyrene, propylstyrene, vinylbiphenyl, vinylnaphthalene, vinylanthracene and mixtures thereof. Also included are stereo block polymers. Copolymers including the already mentioned vinyl-aromatic monomers and comonomers selected from ethylene, propylene, dienes, nitriles, acids, maleic anhydrides, maleic acid amides, vinyl acetate, vinyl chloride and acrylic acid derivatives and mixtures thereof. For example styrene/butadiene, styrene/acrylo-nitrile, styrene/ethylene (interpolymers), styrene/alkyl methacrylate, styrene/butadiene/alkyl acrylate and methacrylate, styrene/maleic anhydride, styrene/acrylonitrile/methyl acrylate; high-impact-strength mixtures consisting of styrene copolymers and another polymer, for example a polyacrylate, a diene polymer or an ethylene/propylene/diene terpolymer; and also block copolymers of styrene, for example styrene/butadiene/styrene, styrene/isoprene/styrene, styrene/ethylene-butylene/styrene or styrene/ethylene-propylene/styrene. Hydrogenated aromatic polymers prepared by hydrogenation of the polymers mentioned above, especially polycyclohexylethylene (PCHE), often also referred to as polyvinylcyclohexane (PVCH), which is prepared by hydrogenation of atactic polystyrene. Hydrogenated aromatic polymers prepared by hydrogenation of the polymers mentioned above. Graft copolymers of vinyl-aromatic monomers, for example styrene on polybutadiene, styrene on polybutadiene/styrene or polybutadiene/acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleic acid imide on polybutadiene; styrene and maleic acid imide on polybutadiene, styrene and alkyl acrylates or alkyl methacrylates on polybutadiene, styrene and acrylonitrile on ethylene/propylene/diene terpolymers, styrene and acrylonitrile on polyalkyl acrylates or polyalkyl methacrylates, styrene and acrylonitrile on acrylate/butadiene copolymers, and mixtures thereof with the copolymers mentioned above, such as those known, for example, as so-called ABS, MBS, ASA or AES polymers. Halogen-containing polymers, for example polychloroprene, chlorinated rubber, chlorinated and brominated copolymer of isobutylene/isoprene (halobutyl rubber), chlorinated or chlorosulphonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate. [0082]9. Polymers derived from .alpha.,.beta.-unsaturated acids and derivatives thereof, such as polyacrylates and polymethacrylates, or polymethyl methacrylates, polyacrylamides and polyacrylonitriles impact-resistant-modified with butyl acrylate. Copolymers of the monomers with other unsaturated monomers, for example acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers. Polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins. Homo- and co-polymers of cyclic ethers, such as polyalkylene glycols, polyethylene oxide, polypropylene oxide or copolymers thereof with bisglycidyl ethers. Polyacetals, such as polyoxymethylene, and also those polyoxymethylenes which contain comonomers, for example ethylene oxide; polyacetals modified with thermoplastic polyurethanes, acrylates or MBS. Polyphenylene oxides and sulphides and mixtures thereof with styrene polymers or polyamides. Polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 11, polyamide 12, aromatic polyamides derived from m-xylene, diamine and adipic acid; polyamide 6/1 (poly-hexamethylene isophthalimide, MXD (m-xylylenediamine); polyamides prepared from hexamethylenediamine and iso- and/or terephthalic acid and optionally an elastomer as modifier, for example poly-2,4,4-trimethylhexamethylene terephthalamide or poly-m-phenylene isophthalamide. Block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or ABS; and polyamides condensed during processing (“RIM polyamide systems”). Examples of polyamides and copolyamides that can be used are derived from, inter alia, .epsilon.-caprolactam, adipic acid, sebacic acid, dodecanoic acid, isophthalic acid, terephthalic acid, hexamethylenediamine, tetramethylenediamine, 2-methyl-pentamethylenediamine, 2,2,4-trimethylhexamethylenediamine, 2,4,4-trimethylhexamethylenediamine, m-xylylenediamine or bis(3-methyl-4-aminocyclohexyl)methane; and also semi-aromatic polyamides such as polyamide 66/61, for example consisting of 70-95% polyamide 6/6 and 5-30% polyamide 6/1; and also tricopolymers in which some of the polyamide 6/6 has been replaced, for example consisting of 60-89% polyamide 6/6, 5-30% polyamide 6/1 and 1-10% of another aliphatic polyamide; the latter may consist of, for example, polyamide 6, polyamide 11, polyamide 12 or polyamide 6/12 units. Such tricopolymers may accordingly be designated polyamide 66/61/6, polyamide 66/61/11, polyamide 66/61/12, polyamide 66/61/610 or polyamide 66/61/612. Polyureas, polyimides, polyamide imides, polyether imides, polyester imides, polyhydantoins and polybenzimidazoles. Polyesters derived from dicarboxylic acids and dialcohols and/or from hydroxycarboxylic acids or the corresponding lactones, such as polyethylene terephthalate, polypropylene terephthalate, polybutylene terephthalate, poly-1,4-dimethylolcyclohexane terephthalate, polyalkylene naphthalate (PAN) and polyhydroxy-benzoates, and also block polyether esters derived from polyethers with hydroxyl terminal groups; and also polyesters modified with polycarbonates or MBS. Polycarbonates and polyester carbonates. Mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

The grafting catalyst comprises transition metal compound, preferably, transition metal oxides.

The oxidizing agent of the present invention is an organic chemical compound capable of generating free radicals, such as a peroxide or azo compound, which is decomposed in the presence of the backbone polymer with the formation of free radicals, which form the active grafting sites on the polymer and initiate the polymerization of the monomer at these sites, such as hydrogen peroxide, t-butyl hydroperoxide. Those oxidizing agents which generate alkoxy radicals, constitute the preferred class of initiators, including acyl peroxides, such as, benzoyl and dibenzoyl peroxides; dialkyl and aralkyl peroxides, such as di-tert-butyl peroxide, dicumyl peroxide, cumyl butyl peroxide,1,1-di-tert-butylperoxy-3,5,5-trimethylcyclohexane, 2,5-dimethyl-2,5-di-tert-butylperoxyhexane, and bis(alpha-tert-butylperoxyisopropylbenzene); peroxy esters, such as tert-butylperoxypivalate, tert-butyl perbenzoate, 2,5-dimethyl-hexyl-2,5-di(perbenzoate), tert-butyl di(perphthalate), tert-butylperoxy-2-ethyl hexanoate, and 1,1-dimethyl-3-hydroxybutylperoxy-2-ethyl hexanoate; and peroxy carbonates, such as di(2-ethylhexyl)peroxy dicarbonate, di(n-propyl)peroxy dicarbonate, and di(4-tert-butylcyclohexyl)peroxy dicarbonate. Azo compounds, such as azobisisobutyronitrile, also may be used. Two or more initiators having the same or different half-lives may be employed.

The reducing agent of the present invention comprises various amine compounds, especially, hydroxylamines and their derivatives.

Examples of the reducing agent include 3-amino-4-hydroxydiphenyl, 3-alkylamino-4-hydroxydiphenyls, 4-amino-3-hydroxydiphenyl, 4-alkylamino-3-hydroxydiphenyls, 2-amino-3-hydroxydiphenyl, 2-alkylamino-3-hydroxydiphenyls, 3-amino-2-hydroxydiphenyl, 3-alkylamino-2-hydroxydiphenyls, 3-amino-4-hydroxydiphenyl ether, 3-alkylamino-4-hydroxydiphenyl ethers, 4-amino-3-hydroxydiphenyl ether, 4-alkylamino-3-hydroxydiphenyl ethers, 2-amino-3-hydroxydiphenyl ether, 2-alkylamino-3-hydroxydiphenyl ethers, 3-amino-2-hydroxydiphenyl ether, 3-alkylamino-2-hydroxydiphenyl ethers, 3-amino-4-hydroxydiphenyl amine, 3-alkylamino-4-hydroxydiphenyl amines, 4-amino-3-hydroxydiphenylamine, 4-alkylamino-3-hydroxydiphenyl amines, 2-amino-3-hydroxydiphenylamine, 2-alkylamino-3-hydroxydiphenyl amines, 3-amino-2-hydroxydiphenylamine, 3-alkylamino-2-hydroxydiphenyl amines, 3-amino-4-hydroxydiphenyl sulfone, 3-alkylamino-4-hydroxydiphenyl sulfones, 4-amino-3-hydroxydiphenyl sulfone, 4-alkylamino-3-hydroxydiphenyl sulfones, 2-amino-3-hydroxydiphenyl sulfone, 2-alkylamino-3-hydroxydiphenyl sulfones, 3-amino-2-hydroxydiphenyl sulfone, 3-alkylamino-2-hydroxydiphenyl sulfones, 3-amino-4-hydroxydiphenyl methane, 3-alkylamino-4-hydroxydiphenyl methanes, 4-amino-3-hydroxydiphenyl methane, 4-alkylamino-3-hydroxydiphenyl methanes, 2-amino-3-hydroxydiphenyl methane, 2-alkylamino-3-hydroxydiphenyl methanes, 3-amino-2-hydroxydiphenyl methane, 3-alkylamino-2-hydroxydiphenyl methanes, 2-phenyl-2-(3-amino-4-hydroxyphenyl)propane, 2-phenyl-2-(3-alkylamino-4-hydroxyphenyl)propanes, 2-phenyl-2-(4-amino-3-hydroxyphenyl)propane, 2-phenyl-2-(4-alkylamino-3-hydroxyphenyl)propanes, 2-phenyl-2-(2-amino-3-hydroxyphenyl)propane, 2-phenyl-2-(2-alkylamino-3-hydroxyphenyl)propanes, 2-phenyl-2-(3-amino-2-hydroxyphenyl)propane and 2-phenyl-2-(3-alkylamino-2-hydroxyphenyl)propanes, 3-amino-3′,4-dihydroxydiphenyl, 3-alkylamino-3′,4-dihydroxydiphenyls, 3-amino-4,4′-dihydroxydiphenyl, 3-alkylamino-4,4′-dihydroxydiphenyls, 4-amino-3,3′-dihydroxydiphenyl, 4-alkylamino-3,3′-dihydroxydiphenyls, 4-amino-3,4′-dihydroxydiphenyl, 4-alkylamino-3,4′-dihydroxydiphenyls, 3-amino-3,4′-dihydroxydiphenyl ether, 3-alkylamino-3,4-dihydroxydiphenyl ethers, 3-amino-4,4′-dihydroxydiphenyl ether, 3-alkylamino-4,4′-dihydroxydiphenyl ethers, 4-amino-3,3′-dihydroxydiphenyl ether, 4-alkylamino-3,3′-dihydroxydiphenyl ethers, 4-amino-3,4′-dihydroxydiphenyl ether, 4-alkylamino-3,4′-dihydroxydiphenyl ethers, 3-amino-3′,4-dihydroxydiphenyl amine, 3-alkylamino-3′,4-dihydroxydiphenyl amines, 3-amino-4,4′-dihydroxydiphenyl amine, 3-alkylamino-4,4′-dihydroxydiphenyl amines, 4-amino-3,3′-dihydroxydiphenyl amine, 4-alkylamino-3,3′-dihydroxydiphenyl amines, 4-amino-3,4′-dihydroxydiphenyl amine, 4-alkylamino-3,4′-dihydroxydiphenyl amines, 3-amino-3′,4-dihydroxydiphenyl sulfone, 3-alkylamino-3′,4-dihydroxydiphenyl sulfones, 3-amino-4,4′-dihydroxydiphenyl sulfone, 3-alkylamino-4,4′-dihydroxydiphenyl sulfones, 4-amino-3,3′-dihydroxydiphenyl sulfone, 4-alkylamino-3,3′-dihydroxydiphenyl sulfones, 4-amino-3,4′-dihydroxydiphenyl sulfone, 4-alkylamino-3,4′-dihydroxydiphenyl sulfones, 3-amino-3′,4-dihydroxydiphenyl methane, 3-alkylamino-3′,4-dihydroxydiphenyl methanes, 3-amino-4,4′-dihydroxydiphenyl methane, 3-alkylamino-4,4′-dihydroxydiphenyl methanes, 4-amino-3,3′-dihydroxydiphenyl methane, 4-alkylamino-3,3′-dihydroxydiphenyl methanes, 4-amino-3,4′-dihydroxydiphenyl methane, 4-alkylamino-3,4′-dihydroxydiphenyl methanes, 2-(3-amino-4-hydroxyphenyl)-2-(3′-hydroxyphenyl)propane, 2-(3-alkylamino-4-hydroxyphenyl)-2-(3′-hydroxyphenyl)propanes, 2-(3-amino-4-hydroxyphenyl)-2-(4′-hydroxyphenyl)propane, 2-(3-alkylamino-4-hydroxyphenyl)-2-(4′-hydroxyphenyl)propanes, 2-(4-amino-3-hydroxyphenyl)-2-(3′-hydroxyphenyl)propane, 2-(4-alkylamino-3-hydroxyphenyl)-2-(3′-hydroxyphenyl)propanes, 2-(4-amino-3-hydroxyphenyl)-2-(4′-hydroxyphenyl)propane and 2-(4-alkylamino-3-hydroxyphenyl)-2-(4′-hydroxyphenyl)propanes, 3,3′-diamino-4-hydroxydiphenyl, 3,3′-di(alkylamino)-4-hydroxydiphenyls, 3,4′-diamino-4-hydroxydiphenyl, 3,4′-di(alkylamino)-4-hydroxydiphenyls, 3′,4-diamino-3-hydroxydiphenyl, 3′,4-di(alkylamino)-3-hydroxydiphenyls, 4,4′-diamino-3-hydroxydiphenyl, 4,4′-di(alkylamino)-3-hydroxydiphenyls, 3,3′-diamino-4-hydroxydiphenyl ether, 3,3′-di(alkylamino)-4-hydroxydiphenyl ethers, 3,4′-diamino-4-hydroxydiphenyl ether, 3,4′-di(alkylamino)-4-hydroxydiphenyl ethers, 3′,4-diamino-3-hydroxydiphenyl ether, 3′,4-di(alkylamino)-3-hydroxydiphenyl ethers, 4,4′-diamino-3-hydroxydiphenyl ether, 4,4′-di(alkylamino)-3-hydroxydiphenyl ethers, 3,3′-diamino-4-hydroxydiphenyl amine, 3,3′-di(alkylamino)-4-hydroxydiphenyl amines, 3,4′-diamino-4-hydroxydiphenyl amine, 3,4′-di(alkylamino)-4-hydroxydiphenyl amines, 3′,4-diamino-3-hydroxydiphenyl amine, 3′,4-di(alkylamino)-3-hydroxydiphenyl amines, 4,4′-diamino-3-hydroxydiphenyl amine, 4,4′-di(alkylamino)-3-hydroxydiphenyl amines, 3,3′-diamino-4-hydroxydiphenyl sulfone, 3,3′-di(alkylamino)-4-hydroxydiphenyl sulfones, 3,4′-diamino-4-hydroxydiphenyl sulfone, 3,4′-di(alkylamino)-4-hydroxydiphenyl sulfones, 3′,4-diamino-3-hydroxydiphenyl sulfone, 3′,4-di(alkylamino)-3-hydroxydiphenyl sulfones, 4,4′-diamino-3-hydroxydiphenyl sulfone, 4,4′-di(alkylamino)-3-hydroxydiphenyl sulfones, 3,3′-diamino-4-hydroxydiphenyl methane, 3,3′-di(alkylamino)-4-hydroxydiphenyl methanes, 3,4′-diamino-4-hydroxydiphenyl methane, 3,4′-di(alkylamino)-4-hydroxydiphenyl methanes, 3′,4-diamino-3-hydroxydiphenyl methane, 3′,4-di(alkylamino)-3-hydroxydiphenyl methanes, 4,4′-diamino-3-hydroxydiphenyl methane, 4,4′-di(alkylamino)-3-hydroxydiphenyl methanes, 2-(3′-aminophenyl)-2-(3-amino-4-hydroxyphenyl)propane, 2-(3′-alkylaminophenyl)-2-(3-alkylamino-4-hydroxyphenyl)propanes, 2-(4′-aminophenyl)-2-(3-amino-4-hydroxyphenyl)propane, 2-(4′-alkylaminophenyl)-2-(3-alkylamino-4-hydroxyphenyl)propanes, 2-(3′-aminophenyl)-2-(4-amino-3-hydroxyphenyl)propane, 2-(3′-alkylaminophenyl)-2-(4-alkylamino-3-hydroxyphenyl)propanes, 2-(4′-aminophenyl)-2-(4-amino-3-hydroxyphenyl)propane and 2-(4′-alkylaminophenyl)-2-(4-alkylamino-3-hydroxyphenyl)propanes, 3,3′-diamino-4,4′-dihydroxydiphenyl, 3,3′-di(alkylamino)-4,4′-dihydroxydiphenyls, 4,4′-diamino-3,3′-dihydroxydiphenyl, 4,4′-di(alkylamino)-3,3′-dihydroxydiphenyls, 2,2′-diamino-3,3′-dihydroxydiphenyl, 2,2′-di(alkylamino)-3,3′-dihydroxydiphenyls, 3,3′-diamino-2,2′-dihydroxydiphenyl, 3,3′-di(alkylamino)-2,2′-dihydroxydiphenyls, 3,3′-diamino-4,4′-dihydroxydiphenyl ether, 3,3′-di(alkylamino)-4,4′-dihydroxydiphenyl ethers, 4,4′-diamino-3,3′-dihydroxydiphenyl ether, 4,4′-di(alkylamino)-3,3′-dihydroxydiphenyl ethers, 2,2′-diamino-3,3′-dihydroxydiphenyl ether, 2,2′-di(alkylamino)-3,3′-dihydroxydiphenyl ethers, 3,3′-diamino-2,2′-dihydroxydiphenyl ether, 3,3′-di(alkylamino)-2,2′-dihydroxydiphenyl ethers, 3,3′-diamino-4,4′-dihydroxydiphenyl amine, 3,3′-di(alkylamino)-4,4′-dihydroxydiphenyl amines, 4,4′-diamino-3,3′-dihydroxydiphenyl amine, 4,4′-di(alkylamino)-3,3′-dihydroxydiphenyl amines, 2,2′-diamino-3,3′-dihydroxydiphenyl amine, 2,2′-di(alkylamino)-3,3′-dihydroxydiphenyl amines, 3,3′-diamino-2,2′-dihydroxydiphenyl amine, 3,3′-di(alkylamino)-2,2′-dihydroxydiphenyl amines, 3,3′-diamino-4,4′-dihydroxydiphenyl methane, 3,3′-di(alkylamino)-4,4′-dihydroxydiphenyl methanes, 4,4′-diamino-3,3′-dihydroxydiphenyl methane, 4,4′-di(alkylamino)-3,3′-dihydroxydiphenyl methanes, 2,2′-diamino-3,3′-dihydroxydiphenyl methane, 2,2′-di(alkylamino)-3,3′-dihydroxydiphenyl methanes, 3,3′-diamino-2,2′-dihydroxydiphenyl methane, 3,3′-di(alkylamino)-2,2′-dihydroxydiphenyl methanes, 2,2-bis(3-amino-4-hydroxyphenyl)propane, 2,2-bis[3-(alkylamino)-4-hydroxyphenyl]propanes, 2,2-bis(4-amino-3-hydroxyphenyl)propane, 2,2-bis[4-(alkylamino)-3-hydroxyphenyl]propanes, 2,2-bis(2-amino-3-hydroxyphenyl)propane, 2,2-bis[2-(alkylamino)-3-hydroxyphenyl]propanes, 2,2-bis(3-amino-2-hydroxyphenyl)propane and 2,2-bis[3-(alkylamino)-2-hydroxyphenyl]propanes, di-(2,2,6,6-tetramethylpiperidin-4-yl) adipate, di-(2,2,6,6-tetramethylpiperidin-4-yl) sebacate di-(2,2,6,6-tetramethylpiperidin-4-yl) phthalate, alpha,alpha′-(di-2,2,6,6-tetramethylpiperidine-4-oxy)-p-xylene, di-(2,2,6,6-tetramethylpiperidin-4-yl) succinate, di-(2,2,6,6-tetramethylpiperidin-4-yl) malonate, di-(1-oxyl-2,2,6,6-tetramethylpiperidin-4-yl) isophthalate, 1-oxyl -2,2,6,6-tetramethylpiperidin-4-yl), 4-hydroxy-1-methoxy-2,2,6,6-tetramethylpiperidine, di-(1-hydroxy-2,2,6,6-tetramethylpiperidin-4-yloxy)-p-xylene, 1-ethoxy-4-hydroxy-2,2,6,6-tetramethylpiperidine, (2,2,6,6-tetramethylpiperidin-4-yl)-[4-(2-oxoazepin-1-yl)-2,2,6,6-tetramethylpiperidin-4-yl]acetate, 3,3′-diamino-4,4′-dihydroxydiphenyl sulfone, 3,3′-di(alkylamino)-4,4′-dihydroxydiphenyl sulfones, 4,4′-diamino-3,3′-dihydroxydiphenyl sulfone, 4,4′-di(alkylamino)-3,3′-dihydroxydiphenyl sulfones, 2,2′-diamino-3,3′-dihydroxydiphenyl sulfone, 2,2′-di(alkylamino)-3,3′-dihydroxydiphenyl sulfones, 3,3′-diamino-2,2′-dihydroxydiphenyl sulfone, 3,3′-di(alkylamino)-2,2′-dihydroxydiphenyl sulfones. Preferably, the reducing agent contains only saturated aliphatic carbon single bonds or aromatic bonds. More preferably, the reducing agent comprises cyclic or aromatic hydroxylamines and their derivatives. Most preferably, the reducing agent comprises hindered amines.

Other than in the operating examples, or where otherwise indicated, all numbers, values and/or expressions referring to quantities of ingredients, reaction conditions, etc., used in the specification and claims are to be understood as modified in all instances by the term “about.”

The following examples illustrate the present invention. Unless otherwise indicated in the following examples and elsewhere in the specification and claims, all parts and percentages are by weight, all temperatures are in degrees Celsius, and pressure is at or near atmospheric pressure.

### Example 1

### Synthesis of allyl substituted 2,2,6,6-teramethyl-piperidin-4-ol (P-1)

Into a 1000 ml four-necked flask were added 250 ml of allyl chloride and 100 g of 2,2,6,6-teramethyl-piperidin-4-ol, both commercially available, the contents of the flask were brought to a temperature of 40 degree C. under agitation for 10 hours. Thereafter, the temperature is raised to the flux temperature with a condenser to remove the un-reacted allyl chloride. Thereafter, the obtained solution was washed with 10 wt % sodium hydroxide and then concentrated by an evaporator.

### Preparation of E-1 Pellets

100 g of ethylene homopolymer with a molecular weight of 1000, 50 g of P-1, 1 g of MoO₃ and 50 g of 2,5-bis(tert-butylperoxy)-2,5-dimethyhexane, all are commercially available except P-1, were mixed in a plastic bag. The mixed content was then transferred to a one liter autoclave equipped with a helix stirrer. The autoclave was heated with heating oil to 120 deg C. and then kept at 120 deg C. for three hours. The autoclave was then heated with heating oil to 150 deg C. and kept at 150 deg C. for another three hours. The molten reactant was poured on the surface of a stainless steel table to form a plastic sheet. The plastic sheet was cut into small pieces (E-1 pellets) by using a cutter manually.

### Preparation of Sample E-1

Sample E-1 was made by mixing E-1 pellets with polypropylene polymer, and then extruded in a 20 mm twin screw extruder under the following conditions:

Formulation: 2 wt % of E-1 pellets, 0.3 wt % of IRGANOX® B 225, 0.5 wt % of zinc stearate and the balance is propylene homopolymer with a MFR of 6.7 dg/min. Except E-1 pellets, the other ingredients were commercially available.

Temperature profile: zone 1: 160 deg C., zone 2: 185 deg C., zone 3: 190 deg C., zone 4: 190 deg C.; zone 5: 190 deg C., extruder head: 185 deg C.

Control sample C-1 was made following the procedure for making Sample E-1 except that E-1 pellets was not added.

Both Sample E-1 and control Sample C-1 were used to make 0.5 mm thick films by compression molding and the stability of the formulation were evaluated by placing the films in a fluorescent sunlight/black light chamber. The time needed to increase the carbonyl absorbance to 0.5 by FTIR on the exposed films is defined as stability time (hour).

TABLE I
Stability Time of Plastic Films

| Sample No. | Stability Time (hour) |
|---|---|
| C-1 | 450 |
| E-1 | 950 |

### Example 2

### Preparation of Sample E-2

Sample E-2 was made by extrusion using a 20 mm twin screw extruder under the following conditions:

Formulation: 2 wt % of P-1, 0.3 wt % of IRGANOX® B 225, 0.5 wt % of zinc stearate, 2 wt % of 2,5-bis(tert-butylperoxy)-2,5-dimethyhexane, 0.1 wt % of MoO₃, 1.0 wt % of nano organoclay, Cloisite 20A, purchased from Southern Clay Products, Inc., 25.0 wt % of ammonium polyphosphate and the balance is propylene homopolymer with a MFR of 6.7 dg/min. Except P-1 pellets, the other ingredients were commercially available.

Temperature profile: zone 1: 160 deg C., zone 2: 185 deg C., zone 3: 190 deg C., zone 4: 190 deg C.; zone 5: 190 deg C., extruder head: 185 deg C.

Control Sample C-2 was made following the procedure for making Sample E-2 except that P-1 was not added.

Both Sample E-2 and control Sample C-2 were used to make 3.0 mm thick plaques by compression molding and the stability of the formulation were evaluated by the flammability of the plaques by subjecting the plaque in a flame for 10 seconds in a vertical position.

TABLE II
Flammability of Plastic Plaques

| Sample No. | after 1^{st} flame (second) | after 2^{nd} flame (second) |
|---|---|---|
| C-2 | Burned completely | n/a |
| E-2 | 2 | 4 |

### Example 3

1000 g of ethylene polymer with a molecular weight of 1000, 200 g of Decanedioic acid, bis(2,2,6,6-tetramethyl-4-piperidinyl) ester, 200 g of 2,5-bis(tert-butylperoxy)-2,5-dimethyhexane and 0.5 g of MoO₃, all commercially available, were mixed in a plastic bag. The mixed content was then transferred to a one liter autoclave equipped with a helix stirrer. The autoclave was heated with heating oil to 120 deg C. and then kept at 120 deg C. for three hours. The autoclave was then heated with heating oil to 150 deg C. and then kept at 150 deg C. with the vent open. After at the temperature of 150 deg C. for three hours, the molten reactant was poured on the surface of a stainless steel table to form a plastic sheet. The plastic sheet was cut into small pieces (E-3 pellets) by using a cutter manually.

Sample E-3 was made by mixing E-3 pellets with a propylene polymer, and then extruded in a 20 mm twin screw extruder under the following conditions:

Formulation: 2 wt % of E-3 pellets, 0.3 wt % of IRGANOX® B 225, 0.5 wt % of zinc stearate, and the balance is propylene homopolymer with a MFR of 6.7 dg/min. Except E-3 pellets, the other ingredients were commercially available.

Temperature profile: zone 1: 160 deg C., zone 2: 185 deg C., zone 3: 190 deg C., zone 4: 190 deg C.; zone 5: 190 deg C., extruder head: 185 deg C.

Control Sample C-3 was made following the procedure for making Sample E-3 except that E-3 pellets were not added.

Both Sample E-3 and control Sample C-3 were used to make 0.5 mm thick films by compression molding and the stability of the formulation were evaluated by placing the films in a fluorescent sunlight/black light chamber. The time needed to increase the carbonyl absorbance to 0.5 by FTIR on the exposed films is defined as stability time (hour).

TABLE III
Stability Time of Plastic Films

| Sample No. | Stability Time (hour) |
|---|---|
| C-3 | 460 |
| E-3 | 900 |

What is claimed is:

1. A process for making a stabilized polymer concentrate comprising:
a) preparing a polymer mixture comprising:
I. about 10.0 to about 98.5 wt % of a polymer material (B);
II. about 0.5 to about 50.0 wt % of at least one reducing agent capable of being reacted with or grafted onto the polymer material (B) in the presence of free radicals;
III. about 0.5 to about 50.0 wt % of an oxidizing agent capable of producing free radicals; and
IV. about 0.01 to about 5.0 wt % of a grafting catalyst;
b) extruding or reacting the polymer mixture at an elevated temperature, thereby producing a stabilized polymer concentrate; and optionally
c) pelletizing the stabilized polymer concentrate, thereby producing a pelletized polymer concentrate.

2. The process according to claim 1 wherein the polymer material (B) is selected from olefin polymers, acrylate polymers, polyesters, polyethers, polyureas, polyamides, polyurethanes, and vinyl polymers.

3. The process according to claim 2 wherein the olefin polymers are selected from:
(a) a crystalline homopolymer of propylene having an isotactic index greater than about 80%, preferably about 90% to about 99.5%;
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;
(c) a crystalline, random terpolymer of propylene and two olefins selected from ethylene and C₄-C₈ α-olefins wherein the polymerized olefin content is about 1% to about 5% by weight, preferably about 1% to about 4%, when ethylene is used, and about 1% to about 20% by weight, preferably about 1% to about 16%, when the C₄-C₁₀ α-olefins are used, the terpolymer having an isotactic index greater than about 85%; and
(d) an olefin polymer composition comprising:
(i) about 10% to about 60% by weight, preferably about 15% to about 55%, of a crystalline propylene homopolymer having an isotactic index at least about 80%, preferably about 90 to about 99.5%, or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, preferably about 90% to about 99%, and an isotactic index greater than about 60%;
(ii) about 3% to about 25% by weight, preferably about 5% to about 20%, of a copolymer of ethylene and propylene or a C₄-C₈ α-olefin that is insoluble in xylene at ambient temperature; and
(iii) about 10% to about 80% by weight, preferably about 15% to about 65%, of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight, preferably about 10% to about 60%, most preferably about 12% to about 55%, of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, preferably 0.1 to 0.3, and the composition is prepared by polymerization in at least two stages;
(e) a homopolymer of propylene having solubility in xylene at room temperature higher than about 20% by weight;
(f) homopolymers of ethylene;
(g) random copolymers of ethylene and an α-olefin selected from C₃-C₁₀ α-olefins having a polymerized α-olefin content of about 1 to about 20% by weight, preferably about 2% to about 16%;
(h) random terpolymers of ethylene and two C₃-C₁₀ α-olefins having a polymerized α-olefin content of about 1% to about 20% by weight, preferably about 2% to about 16%;
(i) homopolymers of butene-1;
(j) paraffin wax;
(k) copolymers or terpolymers of butene-1 with ethylene, propylene or C₅-C₁₀ α-olefin, the comonomer content ranging from about 1 mole % to about 15 mole %; and
(l) mixtures thereof.

3. The process according to claim 1 wherein the reducing agent comprises amine compounds.

4. The process according to claim 1 wherein the reducing agent is selected from hindered amines.

5. The process according to claim 1 wherein the grafting catalyst is selected from transition metal compounds.

6. The process according to claim 1 wherein the stabilized polymer concentrate further comprising nano organoclays.

7. The process according to claim 1 wherein the oxidizing agent is selected from hydrogen peroxide, alkyl hydroperoxides, and dialkyl peroxides.

8. A stabilized polymer material comprising:
(X) about 0.5 to about 50 wt % of a stabilized polymer concentrate made by a process comprising:
a) preparing a polymer mixture comprising:
I. about 10.0 to about 98.5 wt % of a polymer material (B);
II. about 0.5 to about 50.0 wt % of at least one reducing agent capable of being reacted with or grafted onto the polymer material (B) in the presence of free radicals;
III. about 0.5 to about 50.0 wt % of an oxidizing agent capable of producing free radicals; and
IV. about 0.01 to about 5.0 wt % of a grafting catalyst;
b) extruding or reacting the polymer mixture at an elevated temperature, thereby producing a stabilized polymer concentrate; and
(Y) about 1.0 to about 99.5 wt % of a polymer material (B).

9. The stabilized polymer material according to claim 8 further comprises:
(Z) about 0.5 to about 50 wt % of flame retardants.

10. The flame retardants according to claim 9 comprises non-halogenated flame retardants.

11. The flame retardant according to claim 10 comprises ammonium polyphosphate.

12. A process for making a stabilized polymer blend comprises:
a) preparing a polymer mixture comprising:
I. about 1.0 to about 20 wt % of a polymer material (B);
II. about 0.5 to about 50.0 wt % of at least one reducing agent capable of being reacted with or grafted onto the polymer material (B) in the presence of free radicals;
III. about 0.5 to about 50.0 wt % of an oxidizing agent capable of producing free radicals; and
IV. about 0.01 to about 5.0 wt % of a grafting catalyst; and
b) extruding or reacting the polymer mixture at an elevated temperature, thereby producing a stabilized polymer blend; and optionally
c) pelletizing the stabilized polymer blend, thereby producing a pelletized polymer blend.

13. The process according to claim 12 wherein the polymer material (B) is selected from olefin polymers, acrylate polymers, polyesters, polyethers, polyureas, polyamides, polyurethanes, and vinyl polymers.

14. The process according to claim 13 wherein the olefin polymers are selected from:
(a) a crystalline homopolymer of propylene having an isotactic index greater than about 80%, preferably about 90% to about 99.5%;
(b) a crystalline, random copolymer of propylene with an olefin selected from ethylene and C₄-C₁₀ α-olefins wherein the polymerized olefin content is about 1-10% by weight, preferably about 2% to about 8%, when ethylene is used, and about 1% to about 20% by weight, preferably about 2% to about 16%, when the C₄-C₁₀ α-olefin is used, the copolymer having an isotactic index greater than about 60%, preferably at least about 70%;
(c) a crystalline, random terpolymer of propylene and two olefins selected from ethylene and C₄-C₈ α-olefins wherein the polymerized olefin content is about 1% to about 5% by weight, preferably about 1% to about 4%, when ethylene is used, and about 1% to about 20% by weight, preferably about 1% to about 16%, when the C₄-C₁₀ α-olefins are used, the terpolymer having an isotactic index greater than about 85%; and
(d) an olefin polymer composition comprising:
(i) about 10% to about 60% by weight, preferably about 15% to about 55%, of a crystalline propylene homopolymer having an isotactic index at least about 80%, preferably about 90 to about 99.5%, or a crystalline copolymer of monomers selected from (a) propylene and ethylene, (b) propylene, ethylene and a C₄-C₈ α-olefin, and (c) propylene and a C₄-C₈ α-olefin, the copolymer having a polymerized propylene content of more than about 85% by weight, preferably about 90% to about 99%, and an isotactic index greater than about 60%;
(ii) about 3% to about 25% by weight, preferably about 5% to about 20%, of a copolymer of ethylene and propylene or a C₄-C₈ α-olefin that is insoluble in xylene at ambient temperature; and
(iii) about 10% to about 80% by weight, preferably about 15% to about 65%, of an elastomeric copolymer of monomers selected from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a polymerized diene and containing less than about 70% by weight, preferably about 10% to about 60%, most preferably about 12% to about 55%, of polymerized ethylene, and being soluble in xylene at ambient temperature and having an intrinsic viscosity of about 1.5 to about 6.0 dl/g;
wherein the total of (ii) and (iii), based on the total olefin polymer composition is about 50% to about 90% by weight, and the weight ratio of (ii)/(iii) is less than about 0.4, preferably 0.1 to 0.3, and the composition is prepared by polymerization in at least two stages;
(e) a homopolymer of propylene having solubility in xylene at room temperature higher than about 20% by weight;
(f) homopolymers of ethylene;
(g) random copolymers of ethylene and an α-olefin selected from C₃-C₁₀ α-olefins having a polymerized α-olefin content of about 1 to about 20% by weight, preferably about 2% to about 16%;
(h) random terpolymers of ethylene and two C₃-C₁₀ α-olefins having a polymerized α-olefin content of about 1% to about 20% by weight, preferably about 2% to about 16%;
(i) homopolymers of butene-1;
(j) paraffin wax;
(k) copolymers or terpolymers of butene-1 with ethylene, propylene or C₅-C₁₀ α-olefin, the comonomer content ranging from about 1 mole % to about 15 mole %; and
(l) mixtures thereof.

15. The process according to claim 12 wherein the reducing agent comprises amine compounds.

16. The process according to claim 12 wherein the stabilized polymer blend further comprising nano organoclays.

17. The process according to claim 12 wherein the reducing agent is selected from hindered amines.

18. The process according to claim 12 wherein the grafting catalyst is selected from transition metal compounds.

19. The process according to claim 12 wherein the oxidizing agent is selected from organic peroxides.

20. The process according to claim 12 wherein the oxidizing agent is selected from hydrogen peroxide, alkyl hydroperoxides, and dialkyl peroxides.
